(19) United States
(12) Patent Application Publication
(10) Pub. No.: US 2009/0290461 A1
(43) Pub. Date: Nov. 26, 2009

(54) OPTIMIZING CALIBRATION SYSTEM

(75) Inventor: Tony Petrus Van Endert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,490

(22) PCT Filed: Dec. 13, 2005
(86) PCT No.: PCT/IB2005/054210

§ 371 Date: Jun. 12, 2007

(30) Foreign Application Priority Data
Dec. 20, 2004 (EP) 04106721.6

(51) Int. Cl. G11B 7/12

(52) U.S. Cl. 369/47.53; G9B/7

(57) ABSTRACT

An optical scanning device scans a medium via a beam of radiation. The device has a head for providing the beam, beam control means for controlling the beam to generate a scanning spot, a front-end unit for generating a scanning signal based on radiation reflected from the medium, and an adjustment unit for adjusting the beam control means in dependence on detected errors. A beam control parameter, e.g. focus offset, is adjusted by a compromise value based on at least a first calibration value (48) from a first calibration procedure and a second calibration value (49) from a second calibration procedure. The first and second calibration procedures are different and are arranged for providing the respective calibration values for the same beam control parameter in different calibration conditions, for example a calibration (46) based on jitter and a calibration based on wobble detection (47).

The invention relates to a device for scanning a medium via a beam of radiation, the device comprising a head for providing the beam, beam control means for controlling the beam to generate a scanning spot on a scan layer of the medium, and a front-end unit coupled to the head for generating a scanning signal based on radiation reflected from the medium.

The invention further relates to a method of scanning a medium via a beam of radiation, the method comprising controlling the beam to generate a scanning spot on a scan layer of the medium, and generating a scanning signal based on radiation reflected from the medium.

Japan Patent Application 2000-123692, published as JP2001-307330, describes an optical disc device for scanning a scan layer on a medium, for example for recording data on a recording layer of an optical record carrier. The optical recording device is equipped with a servo control system to focus a beam of light from a head to a scanning spot on a track on a recording layer of the record carrier. The servo control system is arranged for being adjusted for taking into account differences in operating conditions. For said adjusting the device may perform a calibration by a learning procedure, or may receive leaning values from a host computer, when mounting a medium in the device. Learning may also be executed when a number of errors, e.g. a number of retrying times, have occurred. A problem of the known servo adjustment system is that the learning values found in practice during a calibration procedure do not consistently solve errors occurring in today's complex scanning devices.

Therefore it is an object of the invention to provide a calibration system in a scanning device that reduces the occurrence of errors in complex scanning conditions.

According to a first aspect of the invention the object is achieved with a scanning device as defined in the opening paragraph, which device comprises adjustment means for adjusting the beam control means in dependence on detected errors by adjusting a beam control parameter of the beam control means by a compromise value based on at least a first calibration value from a first calibration procedure and a second calibration value from a second calibration procedure, the first and second calibration procedures being different and being arranged for providing the respective calibration values for the same beam control parameter in different calibration conditions.

According to a second aspect of the invention the object is achieved with a method as defined in the opening paragraph which method comprises adjusting the beam in dependence on detected errors by adjusting a beam control parameter by a compromise value based on at least a first calibration value from a first calibration procedure and a second calibration value from a second calibration procedure, the first and second calibration procedures being different and being arranged for providing the respective calibration values for the same beam control parameter in different calibration conditions.

The effect of the measures is that, for adjusting a single beam control parameter like focus offset, a multitude of different calibration values is combined to a single compromise value. The different calibration values have been determined under different conditions. The calibration procedures are selected in dependence of errors that occur during use. Based on prior knowledge embedded in the device about the type of errors and the relation between the errors and possible adjustments, the appropriate calibration procedures and calibration values are applied. This has the advantage that an appropriate compromise setting is determined for solving the errors that actually occur.

The invention is also based on the following recognition. In complex, high density optical recording an optimized calibration system may be used for finding an optimum setting, e.g. for a readout signal in preferred, selected circumstances. The inventors have seen that such an optimized system may still encounter error conditions in complex scanning circumstances. For example the single beam parameter may affect two different signals, like a data readout signal and a radial servo control signal, in a different way, i.e. the optimum first calibration value detected for the data readout signal may differ from the second calibration value for the servo control signal. Advantageously the compromise value provides a workable solution for both conditions, while optimizing a first scanning condition while causing substantial detrimental effects in a second scanning condition is prevented.

In an embodiment of the device the beam control means are arranged for controlling a focus position of the scanning spot, and the beam control parameter is an offset parameter for offsetting the focus position. This has the advantage that the focus offset, which affects various elements in the scanning process, is controlled based on offset calibration values of different calibration conditions.

In an embodiment of the device, wherein the scan layer has a pattern of substantially parallel tracks, the beam control means are arranged for controlling a transverse position of the scanning spot with respect to a track, and the beam control parameter is an offset parameter for offsetting the transverse position, in a particular case the pattern being substantially concentric and the transverse position being a radial position. This has the advantage that the transversal or radial offset, which affects various elements in the scanning process, is controlled based on offset calibration values of different calibration conditions.

In an embodiment of the device the front-end unit is arranged for generating, as the scanning signal, a main detector signal for detecting marks in a track on the scan layer and a sub detector signal for detecting a position of the scanning spot with respect to the track, and the first calibration procedure is an offset calibration procedure based on a main quality parameter of the main detector signal and the second calibration procedure is a offset calibration procedure based on a sub quality parameter of the sub detector signal. In particular, the main quality parameter may be based on jitter of signal elements of the main scanning signal due to the marks, and/or the sub detector signal may be a push pull signal due to a transverse variation of the track, in a particular case the transverse variation being a wobble. This has the advantage that a compromise value is applied based on a first calibration based on a quality parameter of the main scanning signal, e.g. jitter of data in the read signal, and a second calibration based on a sub quality of a signal from sub detectors, e.g. amplitude of a push pull signal from sub detectors, or a number of errors when detecting addresses encoded in the wobble. Hence it is prevented that optimizing the main read signal results in errors due to track faulty detection, e.g. errors in detecting of address information encoded in a wobble of the track.

An embodiment of the device is arranged for scanning a medium comprising at least a first scan layer at a first focus setting and a second scan layer at a second focus setting, and the adjustment means are arranged for adjusting the offset parameter by a compromise value based on a first calibration value for the offset parameter from a first calibration procedure at the first scan layer and a second calibration value for the offset parameter from a second calibration procedure at the second scan layer. The different layers in multilayer record carriers, which are positioned at different depths in the medium, have different optimum calibration values, e.g. for the main readout signal based on minimizing jitter. However in specific circumstances, e.g. where the layer depth or layer type is not known in advance, the compromise value has the advantage that workable scanning results are achieved.

Further preferred embodiments of the device according to the invention are given in the further claims.

These and other aspects of the invention will be apparent from and elucidated further with reference to the embodiments described by way of example in the following description and with reference to the accompanying drawings, in which

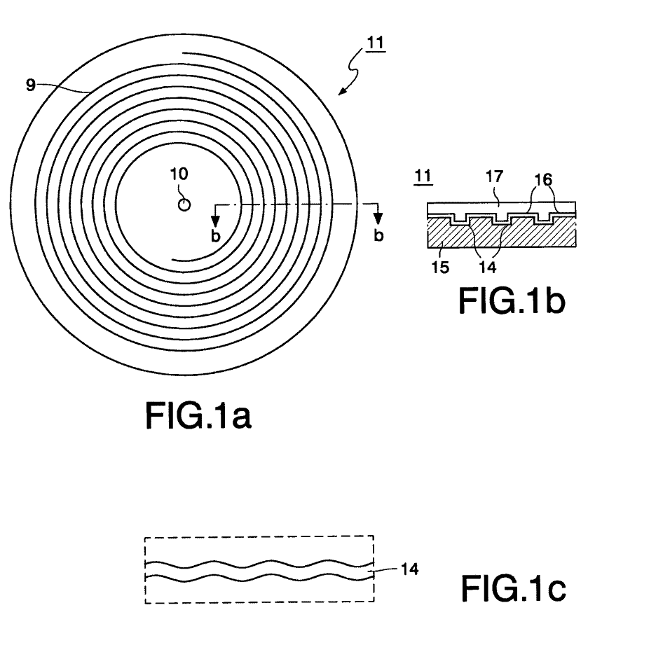

FIG. 1a shows a disc-shaped record carrier,

FIG. 1b shows a cross-section taken of the record carrier,

FIG. 1c shows an example of a wobble of the track,

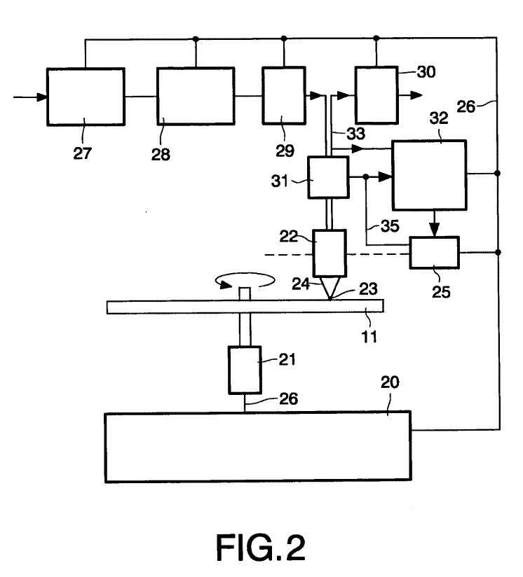

FIG. 2 shows a scanning device having a beam adjustment system,

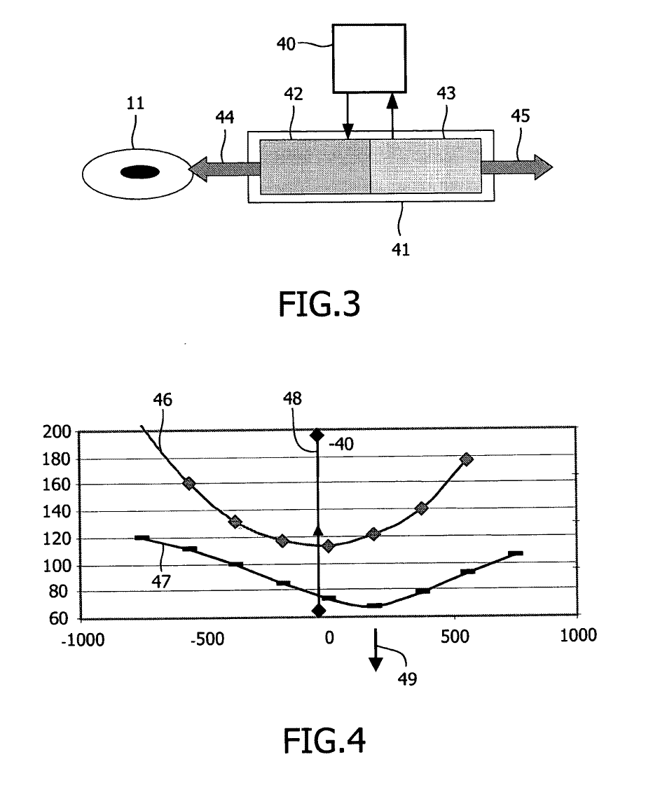

FIG. 3 shows an optical disc system having an optimizing calibration system,

FIG. 4 shows focus offset and calibration values for jitter and wobble,

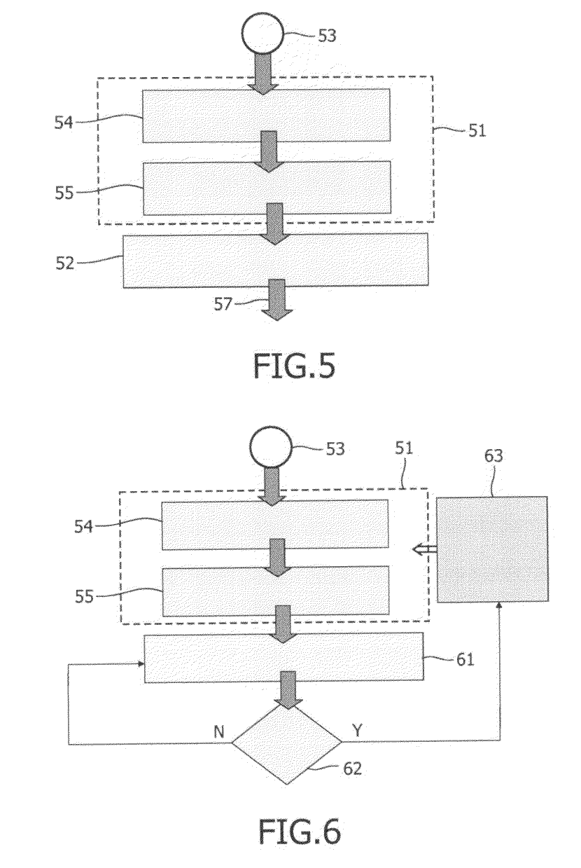

FIG. 5 shows a diagram of basic error processing in an optical device,

FIG. 6 shows adjusting beam control in dependence of errors, and

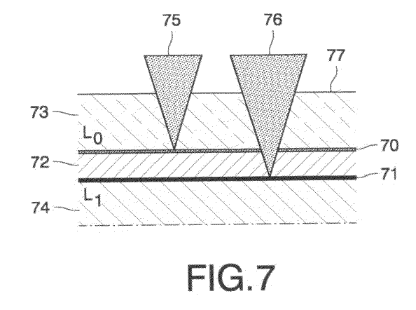

FIG. 7 shows a multilayer optical disc.

In the Figures, elements which correspond to elements already described have the same reference numerals.

FIG. 1a shows a disc-shaped record carrier 11 having a track 9 and a central hole 10. The track 9 is arranged in accordance with a spiral pattern of turns constituting substantially parallel tracks on an information layer. The record carrier may be an optical disc having an information layer of a recordable type. Examples of a recordable disc are the CD-R and CD-RW, and the DVD+RW. The track 9 on the recordable type of record carrier is indicated by a pre-embossed track structure provided during manufacture of the blank record carrier, for example a pregroove. Recorded information is represented on the information layer by optically detectable marks recorded along the track. The marks are constituted by variations of a physical parameter and thereby have different optical properties than their surroundings, e.g. variations in reflection.

FIG. 1b is a cross-section taken along the line b-b of the record carrier 11 of the recordable type, in which a transparent substrate 15 is provided with a recording layer 16 and a protective layer 17. The track structure is constituted, for example, by a pregroove 14 which enables a read/write head to follow the track 9 during scanning. The pregroove 14 may be implemented as an indentation or an elevation, or may consist of a material having a different optical property than the material of the pregroove. A track structure may also be formed by regularly spread sub-tracks which periodically cause servo signals to occur. The record carrier may be intended to carry real-time information, for example video or audio information, or other information, such as computer data.

FIG. 1c shows an example of a wobble of the track. The Figure shows a periodic variation of the transversal position of the track, also called wobble. The variations cause an additional signal to arise in auxiliary detectors, e.g. in a push-pull channel generated by sub detectors or partial detectors in the central spot in a head of a scanning device. The wobble is, for example, frequency modulated and position information is encoded in the modulation. A comprehensive description of the prior art wobble as shown in FIG. 1c in a writable CD system comprising disc control information encoded in such a manner can be found in U.S. Pat. No. 4,901,300 (PHN 12.398) and U.S. Pat. No. 5,187,699 (PHQ 88.002). It is noted that other transversal variations are known which are intended to be detected by variations of reflected radiation by (sub) detectors in a scanning head, such as variations in the width of the track, prepits adjacent to the track, etc.

FIG. 2 shows a scanning device having a beam adjustment system. The device is provided with means for scanning a track on a scan layer of a record carrier 11, which means include a drive unit 21 for rotating the record carrier 11, a head 22, a beam control unit 25 for positioning a scanning spot 23 from the head 22 on the scan layer, a beam control unit 25 and a control unit 20. The head 22 comprises an optical system of a known type for generating a radiation beam 24 guided through optical elements to generate the radiation spot 23 on a track of the information layer of the record carrier. The radiation beam 24 is generated by a radiation source, e.g. a laser diode. The head further comprises (not shown) a focusing actuator for focusing the beam to the radiation spot on the track by moving the focus of the radiation beam 24 along the optical axis of said beam, and a sledge and a tracking actuator for positioning the spot 23 in a direction transverse to the scanning direction of the track on the center of the track. For a disc shaped medium the transverse direction is called radial direction. The tracking actuator may comprise coils for radially moving an optical element or may alternatively be arranged for changing the angle of a reflecting element. The tracking and focusing actuators are driven by actuator signals from the beam control unit 25. For reading the radiation reflected by the information layer is detected by a detector of a usual type, e.g. a four-quadrant diode, in the head 22 for generating detector signals coupled to a front-end unit 31 for generating various scanning signals, including a main detector signal 33 and sub detector signals 35 for tracking and focusing. The sub detector signals 35 are coupled to the beam control unit 25 for controlling said focusing actuators. The main detector signal 33 is processed by read processing unit 30 of a usual type including a demodulator, deformatter and output unit to retrieve the information.

The control unit 20 controls the scanning, e.g. for recording or reading of information, and may be arranged for receiving commands from a user or from a host computer. The control unit 20 is connected via control lines 26, e.g. a system bus, to the other units in the device. The control unit 20 comprises control circuitry, for example a microprocessor, a program memory and interfaces for performing the procedures and functions as described below. The control unit 20 may also be implemented as a state machine in logic circuits.

The device may be provided with recording means for recording information on a record carrier of a writable or re-writable type, for example CD-R or CD-RW, or DVD+RW or BD. The recording means cooperate with the head 22 and front-end unit 31 for generating a write beam of radiation, and comprise write processing means for processing the input information to generate a write signal to drive the head 22, which write processing means comprise an input unit 27, a formatter 28 and a modulator 29. For writing information the power of the beam of radiation is controlled by modulator 29 to create optically detectable marks in the recording layer. The marks may be in any optically readable form, e.g. in the form of areas with a reflection coefficient different from their surroundings, obtained when recording in materials such as dye, alloy or phase change material, or in the form of areas with a direction of polarization different from their surroundings, obtained when recording in magneto-optical material.

In an embodiment the input unit 27 comprises compression means for input signals such as analog audio and/or video, or digital uncompressed audio/video. Suitable compression means are described for video in the MPEG standards, MPEG-1 is defined in ISO/IEC 11172 and MPEG-2 is defined in ISO/IEC 13818. The input signal may alternatively be already encoded according to such standards.

In operation the beam control unit 25 applies a set of beam control parameters for controlling various aspects of the beam. A first example of a beam control parameter is related achieving a correct focus, and is called focus offset. The focus offset is used to provide an adjusted setpoint for the sub detector signals and/or actuator signals that control the focus. A focus offset may for example compensate deviations of the optical system or detector location in the head. A similar example of a beam control parameter is called radial offset, and compensates the transverse position of the scanning spot. Further beam control parameters may be related to the power of the beam, timing of certain signal elements in the beam, etc. In practice beam control may be (partly) implemented software or in other units, such as a laser power control unit or a signal pattern from a recording unit. It is noted that the beam control parameters may require calibration or measurements during manufacture of the device, or may be affected by ageing, temperature, or other actual operational conditions during use of the device, for example as discussed above with reference to JP2001-307330.

The device has a beam adjustment unit 32 for adjusting the beam control unit 25 in dependence on detected errors by adjusting a selected beam control parameter of the beam control unit by a compromise value based on at least a first calibration value from a first calibration procedure and a second calibration value from a second calibration procedure. The first and second calibration procedures are different, i.e. different because they are performed under different calibration conditions and arranged for providing the respective calibration values for the same beam control parameter. For example a focus offset value may be adjusted in the beam control unit 25 by adjusting the setpoint by a compromise focus offset value. The focus offset value is determined by the beam adjustment unit 32, which performs a first calibration function based on detecting errors relating to jitter in the main scanning signal, and a second calibration procedure based on errors in a wobble detection based on a push pull signal. Detailed further examples of calibration and adjustment functions are discussed below with reference to FIGS. 3-7. The focus adjustment unit may also (in part) be implemented as a software function in the control unit 20, and may use signal processing circuitry available in the beam control unit 25, in the front end unit 31, or in the read unit 30, for detecting the selected quality parameter of the detector signal.

FIG. 3 shows an optical disc system having an optimizing calibration system. The figure shows a functional diagram of an optical drive 41. The optical drive has a part called basic engine (BE) 42 for performing the scanning of a medium 11 and a part called data path (DP) 43 for controlling the scanning part and processing data to be read or recorded. The data part 43 has a host interface 45 for communicating with a host, e.g. a computer or a video recorder system, and the basic engine has an optical scanning system 44 for scanning a medium 11 like an optical disc, as schematically indicated by an arrow. The optical drive is provided with a calibration system 40, which is triggered based on errors occurring during operational use and applies prior knowledge to analyze the errors. Based on the analysis an adjustment of the basic engine is performed, wherein a compromise value is calculated from a multitude of calibration values and applied to the basic engine 42 as explained in detail below. Due to the compromise value the overall performance of the actual device in the actual working conditions is optimized.

In operation the optical drive performs various operations as required by commands from the host or by direct user actions, e.g. recording or reading data from the record carrier, or detecting a disc type when the user inserts a new record carrier in the optical drive. During the operations various errors may occur, and both the BE and the DP may include error recovery functions, such as a retry function, changing a detection or control parameter like bandwidth, or execute a calibration procedure. Usually the BE will try to recover from an error at the level where errors occurs. At this level the some system information is available to fix the error. If no recovery is possible in BE an error message is reported to DP. Traditionally the DP may just repeat the command, while taking into account the command time out which may be predetermined or set by the host. If no recovery is possible a fatal error will be reported to the host.

The optical drive according to the invention stores the errors that occur in an error memory, e.g. in an error table storing relevant aspects such as the type of error, or an amount of deviation or a quality indicator. Also during normal operation further criteria may be monitored and stored, such as signal quality parameters like deviations of signals from a target value, or a number of correctable errors during data readout.

The drive is provided with an analysis function to detect patterns or levels from the error memory. The analysis function is based on system knowledge known from designing the optical drive and further problems during development or manufacture of the actual device. For example a lot of errors occur due to the spread of optical parameters in the OPU, but also spread in IC's, etc. Knowledge of the relation between certain types of errors and possible compromise values to mitigate these problems is embedded in the device. The compromise values may require calibration procedures and/or previously measured calibration values, which are also included in the optical drive.

Basically calibration of an optimum of certain control parameters will be done using a certain quality parameter (e.g. jitter). Traditionally a single calibration provides an optimal margin needed in a system to have optimal performance during read and write on an optical storage disc. But, for example due to spread in OPU elements, other operational functions (e.g. wobble detection) could be losing margin and cause errors. Hence a second calibration value is determined and used to calculate the compromise value.

FIG. 4 shows focus offset and calibration values for jitter and wobble. In the diagram on a horizontal axis values for focus offset are given, e.g. in nm or as a correction value. A jitter curve 46 shows measurement values for jitter from a first calibration procedure, while a wobble curve 47 shows measurement values for wobble from a second calibration procedure. The quality of the values is indicated at on the vertical axis, lower values indicating better quality. Note that an optimum jitter calibration value 48 for the focus offset from the jitter calibration procedure has a value of −40 nm. However, an optimum wobble calibration value 49 for the focus offset from the wobble calibration procedure has a value of about +150 nm and is indicated by an arrow.

As shown in the figure, there is a difference between the calibration values for jitter and wobble. Traditionally the consequence would be that margin is lost in the wobble part (resulting in a lower signal to noise ratio SNR), which may cause problems in wobble address read-out on the disc (the ADdress is encoded In the wobble in the Pregroove, called ADIP). Because the read/write system is based on ADIP address read-out we some errors may be expected. The system (BE) will try to recover by e.g. retries as explained below with reference to FIG. 5. If the system cannot recover this error a fatal error will be given by the DP to the host. In this example the traditional approach will cause errors due to the difference between optimal jitter and wobble. The solution is, when such errors are detected, to set the focus unit based on a compromise focus offset value, e.g. FO=(−40+150)/2=+55. Hence the knowledge of the system failure mechanisms is applied by detecting the type of errors, selecting appropriate calibration procedures, and finally adjusting the beam control unit based on compromise values based on a number of different calibration values.

FIG. 5 shows a diagram of basic error processing in an optical device. The upper section of the diagram indicates error handling functions of the basic engine 51. First a problem 53 is detected, for example an error while trying to access a data sector at a specific address, or a low readout signal quality. In a recovery procedure 54 the BE may perform some recovery steps, e.g. a retry and/or adjusting a relevant parameter like the laser power. As a result, the BE provides error messages in an error list 55, for example containing fatal errors, recovered errors and other problems. In the event of a fatal error the BE reports to the data path 52, and the DP may decide to apply a retry if a time-out value allows such retry, otherwise the DP will report the fatal error to the host.

FIG. 6 shows adjusting beam control in dependence of errors. The diagram is an extended version of the diagram in FIG. 5. The error list 55 gives an overview of all possible BE errors that can occur in the basic engine part 51. An analytical mechanism 61 determines which compromise will be used to have a proper recovery of the basic engine part by adjusting parameters in the basic engine, for example parameters related to the beam control such as focus or radial offset, or laser power. Depending on the errors reported in the error list the analytical mechanism 61 will detect a likely cause of the problem. Subsequently in a calibration step 62 it is decided if sufficient information is available for determining a compromise value, and whether the information is sufficiently reliable. Based on the reported errors related, but different, calibration values are selected to be combined to the compromise value. The calibration values may be retrieved from memory (e.g. measured during manufacture or earlier calibrations) or a new calibration procedure may be started when time is available, e.g. as a background process. When the calibration values are available, the compromise value is calculated and an adjustment procedure 63 is performed to apply the compromise value (or values) to the relevant units is the basic engine, such the beam control unit.

The error dependent calibration system may, for every root cause of problems, may cluster some errors to error profiles or patterns, e.g. e few types of errors occurring for a certain disc type. The system will register how many errors for each cluster occur for the drive in the specific conditions, such as for a specific type or brand of record carrier. If a certain cluster of errors frequently occurs, a certain predefined compromise action will be taken. These compromise actions for different errors are stored in the calibration system as prior knowledge, e.g. as part of the analytical learning mechanism 63. The prior knowledge is gathered during development of the drive, or collected during production calibration.

In an embodiment the analytical mechanism 63 also stores results from previous experiences, e.g. types of errors and the respective corrective compromise actions and the final error patterns after the adjustments. By taking into account such previous experiences the calibration system is actually learning to fine tune the adjustments. For example the previous experience could be, for a specific disc type, a compromise between jitter and wobble by giving an extra focus offset situated between the two optimums as explained above with FIG. 4. After the adjustment the learning mechanism determines if the recovery was successful, e.g. measures a new error level or signal quality level. If successful, the adjusted parameter will be stored in a memory such as EEPROM and will be used further in the drive for that disc type.

For specific combinations of media types and/or actual device scanning components specific errors and related calibrations and compromise calculations may be stored in the calibration system of the scanning device, e.g. in a database structure storing error types, patterns or combinations of error types, related control parameters, and calibration procedures to be performed, and calculation rules for the compromise values. In particular for multilayer type media the beam control unit may require adjustments, and specific calibration conditions.

FIG. 7 shows a multilayer optical disc. L0 is a first recording layer 70 and L1 is a second recording layer 71. A first transparent layer 73 covers the first recording layer, a spacer layer 72 separates both recording layers 70, 71 and a substrate layer 74 is shown below the second recording layer 71. The first recording layer 70 is located at a position closer to an entrance face 77 of the record carrier than the second recording layer 71. A laser beam is shown in a first state 75 focused on the L0 layer and the laser beam is shown in a second state 76 focused at the L1 layer. Multilayer discs are available as read-only pre-recorded discs, such as DVD-ROM or DVD-Video. A dual layer DVD+R disc has recently been provided, while writable or rewritable optical storage media having three or more recording layers are considered also. Each recording layer is constituted by a so called stack of material layers. Each recording layer is to be scanned, and different calibration values may be found for each layer, for example for setting a focus offset value. The optimum focus position may depend on the substrate thickness, on the amount of stray light, drive-electronics, and even the type of recording layer, etceteras.

It is to be noted that focus offset adjustment is in particular relevant for multilayer discs, because the spherical aberration is larger due to the ranges of depths of the multitude of recording layers. In an embodiment the recording device is arranged for determining different focus offsets in dependence of different layers of a multilayer type record carrier as the focus offset during recording. Hence the focus adjustment unit 32 is arranged for performing the focus offset determination separately for the different layers that are to be recorded. In particular the focus adjustment unit 32 may store the determined offset values separately in a memory for each layer, and retrieve the offset value determined earlier for a specific layer when an additional recording is to be made on that layer. However, in specific situations, read errors may still occur, for example when several layers have to be scanned with a single setting for focus offset, or during a disc type detection process in which the disc type, and in particular the number of layers or the type of the layer or medium, is not yet known.

In an embodiment the disc type detection process is implemented as follows. Initially an initial focus offset value is applied from a device memory (e.g. EPROM) in the device determined in a calibration procedure during design and/or manufacture. The initial focus offset value is for example based on a single layer (SL) type of disc. As a next step a radial initialization process is started, e.g. for detecting an area of the record carrier having prerecorded disc type information. However, if in practice the record carrier happens to be a dual layer (DL) type, the original disc type detection process may still be successful. However, after some ageing, or in adverse combinations of device components and/or medium types, disc type detection errors may occur. The number of disc type detection errors may be counted and stored, and after a predetermined number of such errors have occurred, i.e. an error threshold for disc type detection errors is exceeded, and a compromise value for the focus offset is set. The compromise value may be an interpolated value between a focus offset value from a calibration procedure for a SL type disc and a focus offset value from a calibration procedure for DL type disc. The calibration values may be separately stored in the device memory during manufacture of the device, or at least one calibration value may be determined or updated by a calibration procedure performed during use of the device in the field, e.g. when a known disc type has been mounted and successfully detected. Alternatively compromise values for specific error conditions may be stored.

By applying compromise values that the optical system is more robust against errors caused by low margins (for example due to components that deviate from average values) by applying compromises between different conditions. By combining calibration values from different conditions the margins are effectively spread over the different parameters. Thus for off-average drives due to spread of key components or unexpected properties of the media still a proper working optical drive is provided for the customer.

Although the invention has been mainly explained by embodiments for controlling a beam for scanning optical discs, the invention is also suitable for other record carriers such as rectangular optical cards, magneto-optical discs or any other type of information storage system that needs control of a scanning spot for scanning a layer on a medium. Moreover the invention is elucidated by examples of applying a compromise value for focus offset of radial offset, but also other system parameters, like power of the radiation beam, may affect various scanning conditions and may be adjusted based on a compromise value detected in at least two different calibration procedures. Also three or more different calibration values, e.g. a factory calibration value, some previous field calibration values and an actual calibration value from a calibration procedure performed when mounting a current medium, may be combined.

It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software. Further, the scope of the invention is not limited to the embodiments, and the invention lies in each and every novel feature or combination of features described above.

1. Device for scanning a medium (11) via a beam of radiation (24), the device comprising
a head (22) for providing the beam,
beam control means (25) for controlling the beam to generate a scanning spot on a scan layer of the medium (11),
a front-end unit (31) coupled to the head for generating a scanning signal (33) based on radiation reflected from the medium, and
adjustment means (32) for adjusting the beam control means (25) in dependence on detected errors by
adjusting a beam control parameter of the beam control means by a compromise value based on at least a first calibration value from a first calibration procedure and a second calibration value from a second calibration procedure, the first and second calibration procedures being different and being arranged for providing the respective calibration values for the same beam control parameter in different calibration conditions.

2. Device as claimed in claim 1, wherein the beam control means are arranged for controlling a focus position of the scanning spot, and the beam control parameter is an offset parameter for offsetting the focus position.

3. Device as claimed in claim 1, wherein the scan layer has a pattern of substantially parallel tracks, and the beam control means are arranged for controlling a transverse position of the scanning spot with respect to a track, and the beam control parameter is an offset parameter for offsetting the transverse position, in a particular case the pattern being substantially concentric and the transverse position being a radial position.

4. Device as claimed in claim 2, wherein
the front-end unit (31) is arranged for generating, as the scanning signal, a main detector signal for detecting marks in a track on the scan layer and a sub detector signal for detecting a position of the scanning spot with respect to the track, and
the first calibration procedure is an offset calibration procedure based on a main quality parameter of the main detector signal and the second calibration procedure is a offset calibration procedure based on a sub quality parameter of the sub detector signal.

5. Device as claimed in claim 4, wherein the main quality parameter is based on jitter of signal elements of the main scanning signal due to the marks.

6. Device as claimed in claim 5, wherein the sub detector signal is a push pull signal due to a transverse variation of the track, in a particular case the transverse variation being a wobble.

7. Device as claimed in claim 2, wherein the device is arranged for scanning a medium comprising at least a first scan layer at a first focus setting and a second scan layer at a second focus setting, and
the adjustment means (32) are arranged for adjusting the offset parameter by a compromise value based on a first calibration value for the offset parameter from a first calibration procedure at the first scan layer and a second calibration value for the offset parameter from a second calibration procedure at the second scan layer.

8. Device as claimed in claim 2, wherein the adjustment means (32) are arranged for adjusting the offset parameter by a compromise value based on a first calibration value for the focus offset parameter from a first calibration procedure for reading marks from the scan layer and a second calibration value for the focus offset parameter from a second calibration procedure for writing marks at the scan layer.

9. Device as claimed in claim 1, wherein the adjustment means (32) are arranged for said adjusting the beam control means (25) in dependence on detected errors by
detecting a multitude of errors,
detecting at least one type of errors within said multitude, and
performing at least one calibration procedure and/or selecting at least one calibration value in dependence of the type of errors.

10. Method of scanning a medium (11) via a beam of radiation (24), the method comprising
controlling the beam to generate a scanning spot on a scan layer of the medium (11),
generating a scanning signal (33) based on radiation reflected from the medium, and
adjusting the beam in dependence on detected errors by
adjusting a beam control parameter by a compromise value based on at least a first calibration value from a first calibration procedure and a second calibration value from a second calibration procedure, the first and second calibration procedures being different and being arranged for providing the respective calibration values for the same beam control parameter in different calibration conditions.
